(19) United States
(12) Patent Application Publication
(10) Pub. No.: US 2023/0065157 A1
(43) Pub. Date: Mar. 2, 2023

(54) METHOD FOR IDENTIFYING ELECTRONIC WHEEL UNITS ON VEHICLE WHEELS OF A VEHICLE, AND USE THEREFOR

(71) Applicant: Continental Automotive Technologies GmbH, Hannover (DE)

(72) Inventor: Michael Löffler, Zeitlarn (DE)

(73) Assignee: Continental Automotive Technologies GmbH, Hannover (DE)

(21) Appl. No.: 17/904,332

(22) PCT Filed: Feb. 9, 2021
(86) PCT No.: PCT/DE2021/200010

§ 371 Date: Aug. 16, 2022

(30) Foreign Application Priority Data
Feb. 18, 2020 (DE) 10 2020 202 029.9

(51) Int. Cl. B60C 23/04; B60C 23/00

(52) U.S. Cl. CPC B60C 23/0416; B60C 23/0462; B60C 23/007; B60C 23/0437; B60C 23/0488; B60C 23/0489

(57) ABSTRACT

The invention relates to a method for identifying electronic wheel units (12-1 to 12-6b) arranged on vehicle wheels (W1-W6b) of a vehicle (1), by means of which method those electronic wheel units (12-3a, 12-3b; 12-4a, 12-4b; 12-5a, 12-5b; 12-6a, 12-6b) which are arranged on vehicle wheels (W3a, W3b; W4a, W4b; W5a, W5b; W6a, W6b) connected to one another for conjoint rotation are identified, the method comprising the steps of: acquiring a respective cumulative number (Ni) of revolutions of each of the vehicle wheels (W1-W6b) using the electronic wheel units (12-1 to 12-6b); comparing with one another the cumulative numbers (Ni) of revolutions of the vehicle wheels (W1-W6b), identifying those electronic wheel units (12-3a, 12-3b; 12-4a, 12-4b; 12-5a, 12-5b, 12-6a, 12-6b) for which the cumulative numbers (Ni) of revolutions at least approximately coincide as being arranged connected to one another for conjoint rotation.

The present invention relates to a method for identifying electronic wheel units which are arranged on vehicle wheels of a vehicle. The invention additionally relates to the use for such a method as well as a vehicle equipped with means for carrying out such a method.

Electronic wheel units arranged on vehicle wheels are known from the prior art of motor vehicles, by means of which electronic wheel units' predetermined operating parameters (e.g., tire pressure, tire temperature, tire load, etc.) of the respective vehicle wheel can be advantageously monitored. Data resulting from the monitoring can, e.g., be forwarded to the vehicle electronics and/or can be used, e.g., in the case of an abnormality (e.g., tire pressure too low) in order to generate information or a warning for a user or driver.

In addition, methods for so-called “localization” of the installation positions of the electronic wheel units arranged on the vehicle wheels of a vehicle are known in this context. In this case, localization means an assignment between the wheel units, on the one hand, or the radio signals which can be assigned to the individual wheel units on the basis of an identification code and, on the other hand, the installation positions (such as, e.g., “front left wheel”, “rear right wheel”, etc.) of the wheel units.

Such localization methods are known, e.g., from the publications DE 10 2009 059 788 B1, WO 2014/044355 A1 and DE 10 2015 212 945 A1. In the case of these methods, the localization is based on an evaluation of correlations between results of acquisitions of rotational positions and/or rotation speeds of the vehicle wheels, which have been carried out, on the one hand, by means of the electronic wheel units and, on the other hand, by means of an axle sensor system (“rotary encoder” on the axles) arranged on the vehicle.

The disadvantage is that these localization methods based on a correlation evaluation do not work if the vehicle has multiple vehicle wheels which are arranged connected to one another for conjoint rotation (on a common axle) of the vehicle, as is the case, e.g., for so-called “dual wheels” (e.g., in the case of heavy trucks).

Other known localization methods are based, e.g., on an evaluation of received signal strengths of radio signals which are sent by the electronic wheel units and received by a radio receiving device arranged on the vehicle. It is possible to extrapolate the installation position, and consequently a localization can be carried out by means of an evaluation of the measured received signal strengths (e.g., “RSSI” value). In order to improve the localization accuracy, e.g., multiple receiving units or receiving antennas arranged at various locations on the vehicle can be provided in order to extrapolate the installation positions, e.g., in accordance with the principle of a “triangulation”.

However, the disadvantage is that these localization methods which utilize a signal strength evaluation frequently do not work sufficiently precisely either in order to be able to distinguish between the installation positions of vehicle wheels arranged close to one another, as is frequently the case, e.g., with vehicle wheels connected to one another for conjoint rotation. It should be noted that, e.g., in the case of heavy trucks, typically whole “bundles” (consisting in each case of, e.g., four dual wheels) are arranged very close to one another so that the corresponding received signal strengths scarcely differ from one another.

In this respect, vehicle wheels connected to one another for conjoint rotation represent, to a certain extent, a disturbing factor in the known localization methods, and are otherwise not considered any further with these methods.

In practice, however, it can be useful, in the most general sense, to identify, from a plurality of electronic wheel units, those which are arranged on vehicle wheels of the vehicle connected to one another for conjoint rotation.

It is an object of the present invention to demonstrate a particularly simple way of identifying electronic wheel units on vehicle wheels of a vehicle, by means of which at least those electronic wheel units which are arranged on vehicle wheels connected to one another for conjoint rotation can be identified.

According to the invention, this object is achieved by a method according to claim 1. The dependent claims relate to advantageous further developments of the invention. The method according to the invention, by means of which those electronic wheel units which are arranged on vehicle wheels of the vehicle connected to one another for conjoint rotation can be identified, comprises the steps of:
acquiring a respective cumulative number of revolutions of each of the vehicle wheels using the electronic wheel units,
comparing with one another the cumulative numbers of revolutions of the vehicle wheels, and
identifying those electronic wheel units for which the cumulative numbers of revolutions at least approximately coincide as being arranged on vehicle wheels connected to one another for conjoint rotation.

In the method according to the invention, it is advantageous that, e.g., neither an axle sensor system arranged on the vehicle nor a device for measuring the received signal strengths of radio signals is required for the identification of the relevant electronic wheel units.

In one embodiment, it is provided that the vehicle has multiple groups of respectively at least two vehicle wheels connected to one another for conjoint rotation. In this case, the corresponding groups of electronic wheel units can be identified with the identification method according to the invention. For example, in the case of a tire pressure monitoring system (TPMS), it is possible in this case, in the event of a pressure loss on a vehicle wheel, to at least obtain the information whether the wheel is a “single wheel” (i.e., not connected to another vehicle wheel for conjoint rotation), or whether it is a vehicle wheel belonging to a group of vehicle wheels connected to one another for conjoint rotation, wherein, in the latter case, e.g., the information can, in addition, be obtained whether the pressure loss merely affects one vehicle wheel of the group or affects multiple (and in this case, how many) vehicle wheels.

In one embodiment, it is provided that the respective cumulative number of revolutions is acquired using an acceleration sensor arranged in the respective electronic wheel unit.

The acceleration sensor can, e.g., supply a sensor signal representative of a radial acceleration. Alternatively or additionally, a differently oriented acceleration, e.g., a tangential acceleration, can also be measured.

In one embodiment, the sensor signal of the (at least one) acceleration sensor is evaluated by a control device of the electronic wheel unit in order to acquire the centrifugal acceleration resulting during the rotation of the vehicle wheel in order to obtain a rotation speed of the vehicle wheel in a time-resolved manner and, by integration over time, to finally obtain the cumulative number of revolutions of the relevant vehicle wheel.

Alternatively or additionally, according to a second embodiment, in which, e.g., a “shock sensor” (sensitive to vibration) or, e.g., a strain gauge can also be deployed alternatively or additionally to an acceleration sensor on the tire material or the like, the cumulative number of revolutions is acquired in that when the vehicle wheel rotates, the passages of the electronic wheel unit through the region of the tire contact area of the vehicle wheel are detected and counted. During such passages, i.e., from an entry into up to an exit from the region of the tire contact area, sensor signals of the above-mentioned types of sensors show easily detectable sensor signal characteristics.

In one embodiment, it is provided that the cumulative numbers are compared with one another and the relevant electronic wheel units are identified by means of a control device (evaluation device) arranged on the vehicle.

Such a control device can be, e.g., a central control device (e.g., ECU) of the vehicle. The individual cumulative numbers of revolutions can, e.g., be acquired by the individual electronic wheel units or the control devices thereof and can be, e.g., transmitted together with further data from time to time (according to a communication strategy) by means of corresponding radio data signals to the vehicle-mounted control device (i.e., arranged on the vehicle). The further data can be wheel operating parameters which have to be monitored such as, in particular, e.g., data regarding tire pressure, tire temperature, etc., as well as an identification code (clearly) characterizing the relevant electronic wheel unit.

In one embodiment, it is provided that the respective cumulative number of revolutions is acquired by means of a counter which is updated with each full revolution of the relevant vehicle wheel, the counter being reset at the start of each journey of the vehicle.

In the case of an autonomous acquisition of the respective cumulative number of revolutions by the relevant electronic wheel unit, this wheel unit contains the indicated counter. The counter can likewise be reset at the start of each journey autonomously by the relevant wheel unit, for instance on the basis of the detection of the end and/or the start of a wheel rotation, e.g., by evaluating a sensor signal from a sensor of the type mentioned above. In one embodiment, the counter is reset at the start of a journey, e.g., it is already reset when a predetermined period of time (e.g., of at least 1 min, or e.g., at least 10 mins) has elapsed following the detection of the last end of a wheel rotation. Alternatively, the counter is only reset immediately after the start of the wheel rotation is detected, although in this case as well, the passage of a predetermined period of time (e.g., at least 1 min or, e.g., at least 10 mins) since the last detection of an end of the wheel rotation can be provided as a prerequisite for resetting the counter.

Alternatively, it is also possible to implement the counters for multiple, in particular all of the, vehicle wheels in the vehicle-mounted control device, the respective electronic wheel units merely transmitting raw data relating to one or more wheel operating parameters to the control device by means of the indicated radio data signals, from which the control device then establishes the respective cumulative numbers of revolutions and can operate the individual counters accordingly. In this embodiment, the resetting of a counter can be triggered both by the relevant wheel unit and by the vehicle-mounted control device.

In one embodiment, it is provided that the electronic wheel units each contain a counter which is continuously updated in accordance with the acquisition of the wheel rotation, in order to count the cumulative number of rotations of the relevant vehicle wheel, but which is not reset during normal vehicle operation, but which can merely be reset, e.g., as a consequence of an active user input (e.g., by workshop personnel). These counters of the electronic wheel units can advantageously be utilized to provide information about the respective mileages of the individual vehicle wheels or the tires thereof. In one embodiment for realizing the present invention, it can, e.g., be provided that the wheel units each have a second counter for the corresponding cumulative number of revolutions, which is, e.g., reset as described above at the start of each journey. In another embodiment, the respective cumulative numbers of revolutions are transmitted by the electronic wheel units by means of the radio data signals sent therefrom to the control device of the vehicle, wherein both the detection of the start of a journey, which may be provided, and the evaluation required to achieve the invention take place in the vehicle-mounted control device on the basis of the information thus transmitted. To this end, memories can, e.g., be configured in the vehicle-mounted control device, which memories are each assigned to one of the electronic wheel units and which, e.g., temporarily store the counter readings of the wheel units which exist at the start of a journey in order to use these temporarily stored values as an “offset” for the comparison when comparing with one another the cumulative numbers of revolutions.

According to a further aspect of the invention, the use of an identification method of the type described here for checking the plausibility of a result of a method for localizing the installation positions of electronic wheel units arranged on vehicle wheels of a vehicle is proposed.

In this case, the localization method can be provided in such a way that the latter supplies a (clear) assignment between the electronic wheel units, on the one hand, and the installation positions of the relevant wheels, on the other hand, as the result.

In this case, the wheel units can in particular be identified, e.g., on the basis of a respective identification (identification code) as a component of radio data signals which are sent by the relevant wheel unit to a vehicle-mounted control device or evaluation device (e.g., central control device). The identification can in particular be, e.g., a numerical identification code which is allocated once and, consequently, clearly identifies the wheel unit.

The installation positions of the vehicle wheels are determined by the configuration of the relevant vehicle. For example, for a truck having two front wheels (left and right) and a typical bundle of dual wheels in the rear region of the vehicle, the installation positions are: front left, front right, rear left outside, rear left inside, rear right outside, rear right inside, rearmost left outside, rearmost left inside, rearmost right outside, rearmost right inside.

In the case of such a localization method, following the assignment between wheel units and installation positions, the plausibility check can consist of verifying this assignment for compatibility with the result of the identification method described here.

Depending on the result of the plausibility check, the result of the localization can then be characterized, e.g., as being unsafe or invalid. Alternatively, it is, e.g., possible, in the case of the localization method, to initially permit up to a predetermined number of different preliminary results (with, e.g., a probability above a certain threshold) in order to then establish a final result of the localization with the aid of the result of plausibility checks for each of these preliminary results (by selecting a result compatible with the result of the identification method).

In one embodiment of the use according to the invention, it is provided that the method for localizing the installation positions of the electronic wheel units comprises the steps of:
evaluating received signal strengths of radio signals which are sent by the electronic wheel units and received by a receiving device arranged on the vehicle (1), and/or
evaluating correlations between results of acquisitions of rotational positions and/or rotation speeds of the vehicle wheels which were carried out, on the one hand, by means of the electronic wheel units and, on the other hand, by means of an axle sensor system arranged on the vehicle.

In the case of an evaluation of received signal strengths (e.g., “RSSI” value) it can in particular, e.g., be provided that the radio signals (preferably radio data signals) are received at multiple different locations of the vehicle and their signal strength gauged in order to extrapolate the installation position utilizing the principle of a triangulation by, e.g., selecting that installation position specified by the design of the vehicle which is closest to the installation position “established by radio”. Alternatively, at least two of the closest design-related installation positions can, e.g., also be selected as preliminary results in order to select a finally established installation position therefrom with the aid of the result of the identification method.

Similarly, when evaluating the correlations between the results of the acquisitions of rotational positions and/or rotation speeds, it can be provided that at least two preliminary assignments (with correlations above a threshold and/or the comparatively highest correlations) are interpreted as preliminary assignments in order to select a final assignment therefrom with the aid of the result of the identification method.

According to a further aspect of the invention, a vehicle equipped with means for carrying out an identification method of the type described here is proposed, in particular for the use of the type described here.

The vehicle can, e.g., be a truck. The vehicle can in each case have a group of multiple (in particular, e.g., two) vehicle wheels connected to one another for conjoint rotation, in each case, e.g., in at least one location on the left and right, viewed in the longitudinal direction of the vehicle. In particular, two such locations can also be provided, e.g., immediately adjacent to one another in the longitudinal direction of the relevant vehicle (resulting in a bundle in each case of at least four vehicle wheels on the left and right in this region).

According to a further aspect of the invention, a computer program product comprising a program code is proposed which, when run on a data processing device (e.g., control device of the vehicle), carries out an identification method of the type described here.

The invention is described further below on the basis of exemplary embodiments with reference to the appended drawings, wherein:

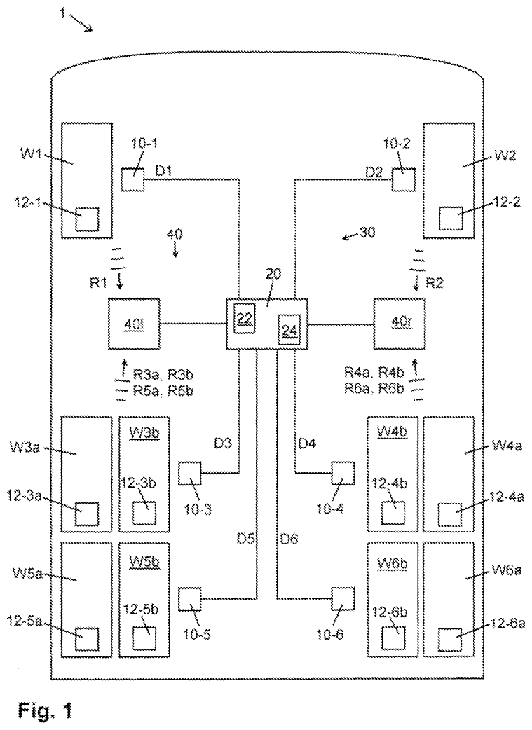

FIG. 1 shows a schematic top view of a motor vehicle, equipped with a system for monitoring the tire pressure,

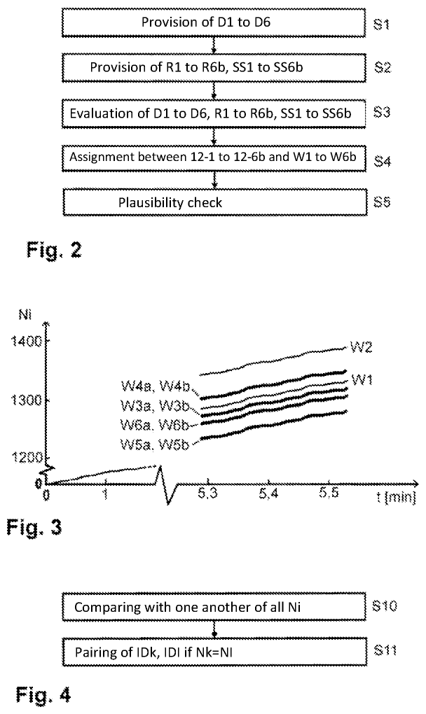

FIG. 2 shows a flow chart of a localization method carried out by means of the system of FIG. 1,

FIG. 3 shows a diagram which illustrates, by way of example, how cumulative numbers of revolutions for the individual vehicle wheels develop over time, and

FIG. 4 shows a flow chart of an identification method additionally carried out by means of the system of FIG. 1 in order to check the plausibility of the localization.

FIG. 1 schematically shows a vehicle 1, e.g., a truck here, having a total of ten pneumatic vehicle wheels W1 to W6b which are arranged at the following installation positions specified by the design of the vehicle 1:

W1: front left, W2: front right

W3a: rear left outside, W3b: rear left inside

W4a: rear right outside, W4b: rear right inside

W5a: rearmost left outside, W5b: rearmost left inside

W6a: rearmost right outside, W6b: rearmost right inside

The vehicle 1 has a tire pressure monitoring system, frequently designated by TPMS, by means of which the respective tire pressure is monitored for the vehicle wheels W1 to W6b.

To this end, the vehicle comprises, as depicted, electronic wheel units 12-1 to 12-6b arranged in each case on one of the vehicle wheels, each containing “mobile measuring means” for measuring the relevant tire pressure and a transmitter for sending radio signals containing radio signal data R1 to R6b, which include data representative of the measured values of the tire pressure as well as an identification code “IDi” of the respective electronic wheel unit (the index i=1 . . . 10 characterizing the relevant one of the ten different electronic wheel units 12-1 to 12-6b in the example).

In order to realize a localization of the individual electronic wheel units 12-1 to 12-6b, which is required for the TPMS, the rotational angular position of the respective vehicle wheel is measured by means of the mobile measuring means and the radio signal data R1 to R6b sent by means of the transmitter additionally contain data representative of the measured values of this “localization parameter” (here: rotational angular position).

Independently of this, vehicle-mounted rotational angle sensors 10-1 to 10-6 are in addition provided (i.e., arranged in a stationary manner with respect to a body of the vehicle 1), which are each assigned to at least one of the above-mentioned installation positions of the vehicle wheels W1 to W6b and, consequently, represent “fixed (vehicle-mounted) measuring means” for measuring the same localization parameter (here: rotational angular position) of the respective vehicle wheel.

The result of the presence of vehicle wheels connected to one another for conjoint rotation (here: W3a to W6b) is that some (here: 10-3 to 10-6) of the rotational angle sensors 10-1 to 10-6 are in each case assigned to multiple (here: two) vehicle wheels:

Sensor 10-1: assigned to vehicle wheel W1

Sensor 10-2: assigned to vehicle wheel W2

Sensor 10-3: assigned to the group of vehicle wheels W3a and W3b

Sensor 10-4: assigned to the group of vehicle wheels W4a and W4b

Sensor 10-5: assigned to the group of vehicle wheels W5a and W5b

Sensor 10-6: assigned to the group of vehicle wheels W6a and W6b

While the signal data R1 to R6 transferred by radio are received via a receiver device 40 and forwarded to a vehicle-mounted control device, in the example a central unit 20, data D1 to D6 generated by the vehicle are transmitted via a digital bus system 30 to the central unit 20. The receiver device 40 is formed by two receiving units 40l, 40r (having respective receiving antennas) arranged at various locations on the vehicle.

The central unit 20 is configured as a program-controlled digital control device containing a computing unit 22 and a memory unit 24 and compares the values of the localization parameter measured by means of the fixed measuring means (here: rotational angle sensors 10-1 to 10-6) of the vehicle 1 with the values of the localization parameter measured by means of the mobile measuring means (in the electronic wheel units 12-1 to 12-6b) in order to establish a correlation between these values and, by analyzing the established correlation, performs an assignment between the electronic wheel units 12-1 to 12-6b and the (aforementioned) installation positions of the vehicle wheels W1 to W6b.

FIG. 2 shows essential steps of the localization method. In a step S1, the data D1 to D6 generated by means of the vehicle-mounted rotational angle sensors 10-1 to 10-6 are provided (communicated via a bus system 30 to the central unit 20).

In a step S2, the radio signal data R1 to R6b generated by means of the sensors mounted on the wheel in the electronic wheel units 12-1 to 12-6b are provided (communicated by radio to the receiver device 40 and onwards via the bus system 30 to the central unit 20). In this case, each of the receiving units 40l, 40r establishes (measures) respective received signal strengths SS1 to SS6b (e.g., so-called RSSI values) for all of the received radio signals containing the radio signal data R1 to R6b, and also communicates these values to the central unit 20.

In a step S3, all of the sensor data D1 to D6 and R1 to R6b are evaluated by the central unit 20, taking into account the received signal strengths SS1 to SS6b.

In a step S4, an assignment is effected between the electronic wheel units 12-1 to 12-6b (to be identified on the basis of their respective identification code IDi) and the (here: ten) installation positions of the vehicle wheels W1 to W6b.

As regards the basic functional principle of steps S3 and S4, the values of the localization parameter measured by means of the fixed measuring means (rotational angle sensors 10-1 to 10-6) can be compared, e.g., with the values of the localization parameter measured by means of the mobile measuring means (in the wheel units 12-1 to 12-6b) in step S3 in order to then establish a correlation between these values, the assignment being performed by a suitable statistical method based on an analysis of the correlation in step S4.

In the depicted example, the procedure for this is as follows: values of the localization parameter measured one after the other (at different times) by means of the respective mobile measuring means are registered (stored) by the central unit 20 for each of the electronic wheel units 12-1 to 12-6b. These values serve as “reference values” for a comparison with a corresponding series of values of the localization parameter measured at the same points in time, which are measured by the fixed measuring means 10-1 to 10-6 on the corresponding axles (“front left”, “front right”, “rear left”, “rear right”, “rearmost left”, “rearmost right”).

During this comparison, a value of the series of reference values is in each case compared with a value belonging to the same measurement time of the series of measured values measured by the fixed measuring means. The result of this comparison can be used, e.g., to establish probabilities which indicate for each of the electronic wheel units 12-1 to 12-6b and each of the installation positions the probability of a certain wheel unit being installed at a certain installation position. Such probabilities can, e.g., be established as a measure of how small a variance (spread) of the values measured by means of the fixed measuring means 10-1 to 10-6 is in each case with respect to the values measured by means of the mobile measuring means of the relevant wheel unit 12-1 to 12-6b. In the depicted exemplary embodiment, the entirety of such variances forms an established “correlation” between the values of the localization parameter measured, on the one hand, on the wheel (by means of the mobile measuring means) and, on the other hand, on the vehicle (by means of the fixed measuring means).

However, since the rotational movements of the vehicle wheels W1 to W6b, which are in each case connected to one another for conjoint rotation, do not differ from one another during the operation of the vehicle 1, an assignment of the relevant vehicle wheels which is only achieved by this correlation analysis would fail or would not supply a clear result.

Therefore, in step S4, multiple possible allocation alternatives are initially determined, from which, taking into account the received signal strengths SS1 to SS6b measured in each case by each of the multiple (here: two) receiving units 40l, 40r (and triangulations carried out therewith and/or other position determinations), that assignment is selected as a result of the localization method, which appears most probable in view of the measured received signal strengths SS1 to SS6b.

Even then, however, the possibility of the localization method supplying an incorrect assignment between wheel units and installation positions is not excluded.

A special feature of the vehicle 1 or of the method carried out by means of the control device 20 is that a very simple method is in addition carried out, by means of which those electronic wheel units (here: 12-3a, 12-3b; 12-4a, 12-4b; 12-5a, 12-5b; 12-6a, 12-6b) which are arranged on vehicle wheels (here: W3a, W3b; W4a, W4b; W5a, W5b; W6a, W6b) of the vehicle 1 connected to one another for conjoint rotation are identified, and which comprises the steps of:
acquiring a respective cumulative number of revolutions of each of the vehicle wheels W1 to W6b using the electronic wheel units 12-1 to 12-6b,
comparing with one another the cumulative numbers of revolutions of the vehicle wheels W1 to W6b, and
identifying those electronic wheel units (here: 12-3a, 12-3b; 12-4a, 12-4b; 12-5a, 12-5b, 12-6a, 12-6b) for which the cumulative numbers of revolutions at least approximately coincide as being arranged connected to one another for conjoint rotation.

This identification method is advantageously used to check the plausibility of the result of the localization method according to steps S1 to S4 (FIG. 2), i.e., following step S4 (FIG. 2), it is further verified in a step S5 whether or not the result of the localization method is compatible with the result of the identification method. Depending on the result of this verification, the result of the localization method can be characterized as being plausible or implausible.

FIG. 3 illustrates, by way of example, how, after the start of a journey (time t=0), cumulative numbers “Ni” of revolutions develop over time for the vehicle wheels W1 to W6b in the vehicle 1.

In the present example, there are ten cumulative numbers Ni (wherein the index i=1 . . . 10 characterizes the relevant one of the ten different vehicle wheels W1 to W6b), and it is assumed that the cumulative numbers Ni of revolutions of all vehicle wheels W1 to W6b were reset, i.e., Ni=0 for all i, at the start of the journey (t=0).

Just a few minutes after the start of the journey there are clear differences between the individual Ni, but the relevant Ni for those of the vehicle wheels W3a to W6b which are connected to one another in pairs for conjoint rotation in the example correspondingly demonstrate relevant values of Ni which are identical in pairs.

By comparing with one another the cumulative numbers Ni of all the vehicle wheels W1 to W6b, the central unit 20 can identify the relevant electronic wheel units 12-3a to 12-6b as being arranged on vehicle wheels connected to one another for conjoint rotation.

In this case, in the present example, of the further total of four groups “12-3a, 12-3b”, “12-4a, 12-4b”, “12-5a, 12-5b” and “12-6a, 12-6b” of electronic wheel units, corresponding to the four groups of vehicle wheels connected in each case to one another for conjoint rotation, “W3a, W3b”, “W4a, W4b”, “W5a, W5b” and “W6a, W6b” are identified. This result of the identification method is used in step S5 (FIG. 2) in order to check the plausibility of the result of the localization method obtained in step S4.

Whereas in the localization method known in principle from the prior art, the radio signal data R1 to R6b obtained by means of the electronic wheel units 12-1 to 12-6b are each compared with all of the data D1 to D6 obtained by means of the “fixed” (vehicle-mounted) measuring means (in order to perform a statistical analysis), merely the cumulative numbers of revolutions Ni comprised, e.g., by the radio signal data R1 to R6b are compared with each other during the identification method, which makes it possible to identify said groups of vehicle wheels very simply and reliably.

FIG. 4 shows a flow chart of the identification method. In a step S10, all of the numbers of revolutions Ni are compared with one another, and in a step S11, those identification codes IDk, IDl (where k≠l, k=1 . . . 10 and l=1 . . . 10) of those electronic wheel units are “paired” (i.e., the corresponding electronic wheel units viewed as being arranged on a vehicle wheel of a group of vehicle wheels connected to one another), for which Nk=Nl applies at least approximately. In order to verify this criterium, an estimated measurement accuracy of the acquisition of the cumulative numbers Ni can, e.g., be expediently considered. For example, Nk and Nl can be deemed to be at least approximately identical if one of the two values is, e.g., a maximum of 0.5% or, e.g., is a maximum of 1% greater than the other value. It goes without saying that such a tolerance threshold (based on the measurement accuracy) also depends on that period of time over which the revolutions of the vehicle wheels W1 to W6b were counted (accumulated) or, in this context, also depends on the accumulated total number itself. In one embodiment, the tolerance threshold is therefore specified as a function of at least one of the values of Nk and Nl and/or as a function of a time span of the accumulation.

In the example it is provided that the respective cumulative number Ni of revolutions is acquired using an acceleration sensor arranged in the respective electronic wheel unit 12-1 to 12-6b, which supplies, e.g., a sensor signal representative of a radial acceleration. The sensor signal of the (at least one) acceleration sensor is evaluated by a control device of the electronic wheel unit in order to establish the cumulative number of revolutions Ni of the relevant vehicle wheel W1 to W6b.

The cumulative numbers Ni are compared with one another and the relevant electronic wheel units are identified by means of a control device arranged on the vehicle, which is implemented in the example by the central unit 20.

The individual cumulative numbers Ni of revolutions are acquired by the individual electronic wheel units 12-1 to 12-6b or the control devices thereof and are transmitted, together with further data (relating to wheel operating parameters as well as the identification code IDi) from time to time by means of the radio data signals R1 to R6b to the central unit 20.

In the example, it is provided that the respective cumulative number Ni of revolutions is acquired by means of a counter which is updated with each full revolution of the relevant vehicle wheel, the counter being configured in the control device of the relevant electronic wheel unit and being reset at the start of each journey of the vehicle.

The counter is reset at the start of each journey autonomously by the relevant wheel unit. To this end, the start of a wheel rotation is detected by evaluating the sensor signal of the acceleration sensor.

Moreover, the methods described can also be used in combination with other further localization principles. By combining these methods, it is possible to obtain a complete localization (including of the dual tires).

An example of one of these additional methods is LSE (Localization by Synchronized Emission). Each TPMS sensor recognizes a fixed, predefined angle and one or more associated items of protocol information is output wirelessly. A computer program on the vehicle uses one or more transmitted items of protocol information which are output at certain time intervals, together with the stored ABS signal values for each wheel (ABS tick value), in order to calculate a correlation (temporal recalculation in order to determine the tick value of the sensor position at which the sensor has recognized the predefined angle).

As an example:
Actual position of TPMS sensor A→front left (FL) mechanically connected to ABS sensor 1
Actual position of TPMS sensor B→front right (FR)→mechanically connected to ABS sensor 2
Actual position of TPMS sensor C→rear right (RR), mechanically connected to ABS sensor 3
Actual position of TPMS sensor D→rear left (RL), mechanically connected to ABS sensor 4
Actual position of TPMS sensor E→rear right (RR), mechanically connected to ABS sensor 3 and dual tire partner/dual sensor of C
Actual position of TPMS sensor F→rear left (RL), mechanically connected to ABS sensor 4 and dual tire partner/dual sensor of D

The sensor software for TPMS sensors A, B, C and D contains sensor software part 1 (SSW1)+sensor software part 2 (SSW2). With SSW1, the TPMS sensor is able to recognize a predefined angle. With SSW2, the TPMS sensor is able to count each wheel revolution of the wheel in which the TPMS sensor is installed. The sensor software of TPMS sensors E and F only requires sensor software part 2 (SSW2), since the TPMS sensor counts each wheel revolution, but does not transfer any related information to the LSE localization process.

Following the successful localization process (LSE) with TPMS sensors A, B, C and D, another computer program compares all the counters of TPMS sensors A to F in the vehicle. In this way, TPMS sensor E which has the same counter value as TPMS sensor C can be localized as a dual tire pair. Likewise, sensor F which has the same counter value as TPMS sensor D can be identified as a dual tire pair. In this example, this combined localization is based on vehicles in which ABS sensor signals exist on each axle to be localized, but other localization processes can also be used.

1. Use of an identification method to check the plausibility of a result of a localization method,
the localization method being provided to localize the installation positions of electronic wheel units (12-1 to 12-6b) arranged on vehicle wheels (W1-W6b) of a vehicle (1), and comprising an evaluation of received signal strengths of radio signals which are sent by the electronic wheel units (12-1 to 12-6b) and received by a receiving device (40l, 40r) arranged on the vehicle (1),
the identification method being provided to identify those electronic wheel units (12-3a, 12-3b; 12-4a, 12-4b; 12-5a, 12-5b, 12-6a, 12-6b) which are arranged on vehicle wheels (W3a, W3b; W4a, W4b; W5a, W5b; W6a, W6b) connected to one another for conjoint rotation,
and the identification method comprising the steps of:
acquiring a respective cumulative number (Ni) of revolutions of each of the vehicle wheels (W1-W6b) using the electronic wheel units (12-1 to 12-6b),
comparing with one another the cumulative numbers (Ni) of revolutions of the vehicle wheels (W1-W6b), and
identifying those electronic wheel units (12-3a, 12-3b; 12-4a, 12-4b; 12-5a, 12-5b, 12-6a, 12-6b) for which the cumulative numbers (Ni) of revolutions at least approximately coincide as being arranged connected to one another for conjoint rotation.

2. The use according to claim 1, wherein the respective cumulative number (Ni) of revolutions is acquired using an acceleration sensor arranged in the respective electronic wheel unit (W1-W6b).

3. The use according to any one of the preceding claims, wherein the cumulative numbers (Ni) are compared with one another and the relevant electronic wheel units (12-3a, 12-3b; 12-4a, 12-4b; 12-5a, 12-5b; 12-6a, 12-6b) are identified by means of a control device (20) arranged on the vehicle (1).

4. The use according to any one of the preceding claims, wherein the respective cumulative number (Ni) of revolutions is acquired by means of a counter which is updated with each full revolution of the relevant vehicle wheel (W1-W6b), the counter being reset at the start of each journey of the vehicle (1).

5. The use according to any one of the preceding claims, wherein, depending on the result of the plausibility check, the result of the localization method is characterized as being unsafe or invalid.

6. The use according to any one of the preceding claims, wherein during the localization method, various preliminary results are initially permitted up to a predetermined number, in order to then establish a final result of the localization method, with the aid of the result of plausibility checks for each of these preliminary results, by selecting a result compatible with the result of the identification method.

7. A vehicle (1), equipped with means (10-1 to 10-6, 12-1 to 12-6b, 40l, 40r, 20) for realizing the use according to any one of the preceding claims.

8. A computer program product comprising a program code which, when run on a data processing device, carries out the use according to any one of claims 1 to 6.
